(19) United States
(12) Patent Application Publication
(10) Pub. No.: US 2008/0046389 A1
(43) Pub. Date: Feb. 21, 2008

(54) Method of marketing a product

(75) Inventor: Jason C. Cohen, Appleton, WI (US)

Correspondence Address: KIMBERLY-CLARK WORLDWIDE, INC.;Catherine E. Wolf, 401 NORTH LAKE STREET, NEENAH, WI, 54956, US

(73) Assignee: Kimberly-Clark Worldwide, Inc.

(21) Appl. No.: 11/506,056

(22) Filed: Aug. 17, 2006

(51) Int. Cl. G06Q 90/00

(52) U.S. Cl. 705/500

(57) ABSTRACT

A method of marketing a product includes providing a unique scent with a first intensity contemporaneously with a first unrelated positive stimulus in the absence of the product, wherein the first positive stimulus has a first strength. The method further includes later providing the unique scent with a second intensity contemporaneously with a second unrelated positive stimulus in the absence of the product, wherein the second positive stimulus has a second strength, wherein the second intensity of the scent is greater than the first intensity of the scent, and wherein the second strength of the second stimulus is greater than the first strength of the first stimulus. The method further includes later providing the product with the unique scent.

### BACKGROUND OF THE INVENTION

The sense of smell has a powerful connection with the emotional state of humans. Manufacturers have long appreciated the impact that scent has on purchasing decisions made by consumers. As such, various consumer products such as shampoos, deodorants, disposable diapers, cosmetics, and the like have included fragrances for a variety of reasons, including for example, to increase a consumer's preference for and/or impression of the given product.

Additionally, scents have been used more subtly in selling goods and services. For example, movie theaters have provided the scent of popcorn throughout the theater and/or near the sidewalk in front of the theater to evoke a response in potential moviegoers to see a movie and/or purchase popcorn. Likewise, the use of scents, such as baking bread or vanilla, has been employed to help sell homes. Furthermore, sales presentations of new cars have included the new car smell to enhance the selling power of the presentation.

Previously published research (e.g., Pamela Dalton's findings prepared for the U.S. Army Medical Research and Material Command under grant number DAMD17-01-1-0782) has suggested that subjects may associate either a positive or negative response to a particular odorant depending upon the conditions of the initial exposure to the odorant. This is called odor-stress conditioning. In these studies, scientists evaluated the degree to which a physiological state (e.g., relaxation or stress) initially experienced in the presence of a new odor could later be elicited by the odor alone. One group of subjects was first presented with a novel odor while in a relaxing situation, such as viewing a slide show. The other group of subjects was first presented with the novel odor while performing stressful tasks, such as giving public speeches and rapidly performing mathematical subtractions. Upon re-exposure to the odor at a later time, the subjects initially conditioned in the stressful situation had higher self-reported stress, higher disruptions in cognitive performance, and higher change in heart rate as compared to those subjects initially conditioned in the relaxing situation. These results suggest that the ability to induce stress or relaxation (negative or positive response) in a subject may be achieved through odor conditioning. As such, it is believed that a subject's reaction to various odors is highly dependent on the conditions by which the odor is originally presented and learned. However, despite this increased understanding of odors, there still exists a need for a method of marketing a product that utilizes odor conditioning to trigger a positive response in consumers when exposed to the product.

### SUMMARY OF THE INVENTION

In response to this need, in one aspect, the present invention provides a method of marketing a product that includes providing a unique scent contemporaneously with an unrelated positive stimulus in the absence of the product and later providing the product with the unique scent.

In various embodiments, the stimulus does not direct attention to the product to be marketed. In various embodiments, the stimulus does not direct attention to the scent. In various embodiments, the stimulus does not direct attention to the product to be marketed or to the scent.

In some embodiments, the method may further include providing the unique scent contemporaneously with a second unrelated positive stimulus in the absence of the product. In some embodiments, the first stimulus may have a first value and the second stimulus may have a second value greater than the first value.

In various embodiments, the positive stimulus may be a gift pack, coupons, or food. In various embodiments, the product may be a diaper, wipe, children's toiletry, bath tissue, or facial tissue.

In another aspect, a method of marketing a product includes the step of providing a unique scent with a first intensity contemporaneously with a first unrelated positive stimulus in the absence of the product wherein the first unrelated positive stimulus has a first strength. The method further includes the later step of providing the unique scent with a second intensity contemporaneously with a second unrelated positive stimulus in the absence of the product wherein the second unrelated positive stimulus has a second strength. The method further includes the later step of providing the product with the unique scent.

In various embodiments, the first stimulus may be a different type of stimulus than the second stimulus. In various embodiments, the second intensity of the scent may be greater than the first intensity of the scent.

In various embodiments, the first positive stimulus may be a coupon having a first value and the second positive stimulus may be a coupon having a second value wherein the second value is greater than the first value. In various embodiments, the second strength of the second stimulus may be greater than the first strength of the first stimulus. In various embodiments, the second intensity of the scent may be greater than the first intensity of the scent.

In various embodiments, the first and second stimuli do not direct attention to the product. In various embodiments, the first and second stimuli do not direct attention to the scent. In various embodiments, the first and second stimuli do not direct attention to either the product or the scent.

In another aspect, a method of marketing a product includes the step of providing a unique scent with a first intensity contemporaneously with a first unrelated positive stimulus in the absence of the product, wherein the first positive stimulus has a first strength. The method further includes the later step of providing the unique scent with a second intensity contemporaneously with a second unrelated positive stimulus in the absence of the product, wherein the second unrelated positive stimulus has a second strength and wherein the second intensity of the scent is greater than the first intensity of the scent and wherein the second strength of the second stimulus is greater than the first strength of the first stimulus. The method further includes the later step of providing the product with the unique scent.

In various embodiments, the first and second stimuli do not direct attention to the product. In various embodiments, the first and second stimuli do not direct attention to the scent. In various embodiments, the first and second stimuli do not direct attention to either the product or the scent.

### DETAILED DESCRIPTION OF THE INVENTION

As Dalton and others have found, the presentation of one or more stimuli can yield predictable responses in subjects. For example, stressful stimuli have been found to result in increased self-reported stress levels along with other responses. Presentation of these stimuli contemporaneously with a scent can create an association between the scent and the response to the stimuli. Based on this association, re-exposure to the scent can elicit the response without the stimuli being present because of the association that has been developed.

This invention utilizes this learning and applies these concepts to various methods of marketing consumer products. More specifically, the present invention includes methods of conditioning consumers to have a positive response when exposed to one or more unique scents and then marketing products having these unique scents. It is believed that the positive responses associated with the scent will be transferred to the products thereby creating an initial positive response to the marketed products.

As used herein, the terms “scent,” “odor,” “fragrance,” “odorant,” and the like, refer to effluvia from a substance that affect the sense of smell and are used interchangeably.

The present invention provides a method of marketing a product that includes the step of providing to a subject a unique scent contemporaneously with an unrelated positive stimulus in the absence of the product. Providing a positive stimulus is believed to yield a positive response in the subject. The positive response is experienced contemporaneously with the unique scent and is believed to result in the formation of a positive association between the unique scent and the response. This positive response can be recreated in the subject at a later time by exposing the subject to the unique scent in conjunction with the product to be marketed. As such, the method further includes the step of providing the product to be marketed with the unique scent. It is believed that the unique scent presented in conjunction with the product will elicit the positive response in the subject based on the earlier association. The positive response may then be triggered by the scented product thereby effectively transferring the positive response associated with the scent to the product.

As used herein, the term “positive response” refers to reactions by humans to various stimuli. For example, positive responses can include, feelings of contentedness, happiness, calm, joy, love, and the like, and combinations thereof. Likewise, positive responses can include, for example, physical responses such as reduced blood pressure, reduced pulse, reduced muscle tension, and the like, and combinations thereof.

As used herein, the term “unique scent” refers to an odor not previously associated by the subject with a given product. For example, if marketing new cars, the “new car smell” is not a unique scent because the “new car smell” is already associated by most subjects with new cars. Likewise, if marketing popcorn, the smell of popcorn is not a unique scent because it is already associated by most subjects with popcorn. However, the use of the popcorn smell to market new cars may be a unique scent because the popcorn odor has not previously been associated by most subjects with new cars.

As used herein, the term “in the absence of the product” refers to the situation wherein the product being marketed is not the source of the odor being initially associated with the positive stimulus. For example, perfume samplers are commonly found in magazines. The perfume may have a unique scent, but when the subject smells the sampler, they actually smell the perfume. In other words, the source of the odor is the product to be marketed. Therefore, in this situation, the subject is not exposed to the odor “in the absence of the product” as used herein.

As used herein, the term “unrelated” refers to scents and stimulus having no apparent connection. For example, a coupon provided as a positive stimulus is unrelated to the scent of mint provided therewith because there is no apparent connection between a coupon and mint. In contrast, providing a free sample of watermelon as a positive stimulus is related to the scent of watermelon because the connection between an actual watermelon and the scent of watermelon is apparent.

In various embodiments, the positive stimulus may be provided by any suitable means and in any suitable form, such as, for example, coupons, gifts, money, toys, food, humor, advice, and the like, and combinations thereof. In general, the positive stimulus may be any object provided to a subject/consumer that is likely or expected to produce a positive response. In various embodiments, the stimulus may have the same form but have different values. For example, a coupon worth $2 may be provided to a subject as well as a coupon worth $1. In both situations, the stimuli have the same form, i.e., coupons, but have different values. In various embodiments, the stimuli may be provided in different forms and/or provided with different strength and/or value. For example, a coupon may be provided as a first stimulus and a poem may be provided as a second stimulus having a different form than the first.

In various embodiments, the unique scent may be provided by any suitable means whether provided in conjunction with the stimulus and/or with the product. For example, the scent may be diluted in the form of a liquid solution, aerosol spray, solid, microcapsules, or other suitable forms, or combinations thereof, such that the consumer experiences the scent contemporaneously with the positive stimulus and/or the product. In some embodiments, a fragrance may be microencapsulated and contained within one or more substrate layers, such as an adhesive layer, such that when the layer or layers are separated at least some of the microcapsules are ruptured thereby releasing the fragrance contained therein.

In various embodiments, the unique scent may have different perceived intensities. For example, a scent may have a perceived intensity of just below threshold up to just below irritant levels as measured by the methods of Wise et al. in “Temporal Integration in Nasal Lateralization and Nasal Detection of Carbon Dioxide” published at Chem. Senses 29: 137-142, 2004.

In some embodiments, the method may or may not direct the subjects' attention to the product and/or the presence of the scent. As used herein, the term “direct attention to” refers to overt communications through visual cues and/or auditory cues. For example, a coupon for a diaper directs attention to the diaper. Likewise, a printed message that indicates that a fragrance is present directs attention to the fragrance. In contrast, providing no writing, figures, or other visual cues as to the presence of a fragrance does not “direct attention to” the fragrance. While, the subject may be able to smell the scent and may therefore be aware of the presence of the scent, this is not “directing attention” to the scent.

In one embodiment, a method of marketing a product may include a promotional game wherein game pieces are provided from any suitable source (e.g. from newspaper, direct flyers, etc.) and are provided to prospective consumers. The game pieces are provided in conjunction with a scent. The scent may be immediately available or may require “activation” by the consumer. For example, the consumer may be directed to scratch off a portion of the game piece to reveal various indicia, such as, for example, prizes, coupons, and the like, and combinations thereof. The scratch off portion may include a unique fragrance at various level of intensity (e.g., just above threshold) that is released upon scratching. When the consumer scratches off the material, the fragrance is released contemporaneously with the consumer receiving the coupon. It is believed that the consumer will have a positive response to receiving the coupon. It is also believed that this positive response will be associated with the unique fragrance. Once the association has been developed, the fragrance may then be added to various products to trigger a positive response to the product containing the scent. Based on the concept of positive conditioning, the positive response of receiving a game piece, a coupon, or a chance to win a larger prize will be associated with that unique fragrance. As such, the method includes providing the product to be marketed in conjunction with the unique fragrance. Therefore, when shopping for or using the product, the positive association previously developed between the unique scent and the positive response will transfer to the product being marketed and may increase purchase interest and/or enhance the experience of buying and/or using the product.

In another embodiment, each game piece may be provided with a single odiferous note so a complete fragrance would emerge once all of the game pieces are collected. The complete fragrance may then be added to the product to be marketed. For example, two game pieces may be used wherein the first game piece provides ½ a coupon and provides a first scent (e.g., apple) and the second piece provides the remaining half of the coupon and provides a second scent (e.g., cinnamon). When the two halves are combined, the consumer has an entire coupon and experiences the entire fragrance (e.g., apple cinnamon). Alternatively, the unique fragrance may be presented on all pieces, at below threshold levels. However, when all the game pieces are combined there is enough intensity to be detected.

Additionally, or alternatively, the method may include the step of instructing the consumer to combine the entire coupon. The combination of the coupon may be adapted to trigger the release of the fragrance. For example, the two pieces of coupon could include peel off tape that releases the respective fragrances at the time of assembly of the whole coupon thereby preserving the odor until the stimulus (i.e., the coupon) is complete such that the fragrance is experienced contemporaneously with the stimulus.

In some embodiments, the positive stimulus and the unique scent may be presented to the consumer before the consumer has a need for the product being marketed to begin to develop a positive response to a particular scent. In these embodiments, the association between the scent and the response is developed before marketing the product to the particular consumer. Later when the consumer has a need for the product, the product is provided with the scent which triggers the consumer's positive response that results from the previously developed positive association. The positive response may then be transferred to the product.

For example, a gift set may be sent to expectant mothers. The gift set includes a unique scent but does not include the product to be marketed (e.g., disposable diapers). Instead, the gift set includes items that are likely to stimulate a positive response in the expectant mothers, such as, for example, spa accessories, chocolates, parenting books, gift certificates, tickets to a show, and the like, and combinations thereof. Therefore, it is believed that the recipient of the gift will have a positive response to receiving the gift set while contemporaneously experiencing the unique scent. As a result, the recipient associates the positive response with the scent thereby creating a positive association with the scent. The same scent may be then added to the product being marketed. When the recipient of the gift smells the scent on the specific product she is likely to experience a positive response to the specific product as a result of the positive association with the unique scent being transferred to the product to be marketed. Therefore, even though the recipient may have no familiarity with the specific product being marketed she already has a positive initial response to the product.

In another example, the stimulus may include the ultrasound image frequently received by expecting mothers during their pregnancies. The ultrasound image may include the unique scent in any suitable form. For example, the paper on which the image is printed may be impregnated with the scent or sprayed with the scent or a scented frame may be included. It is believed that the experience of seeing the ultrasound image is a powerful positive stimulus for expecting parents and therefore produces a powerful positive response. It is also believed that providing the unique scent contemporaneously therewith will create a strong positive association between the positive response of the parents and the scent. As such, the method of this embodiment therefore also includes providing various baby care products including the scent to consumers. For example, suitable baby care products may include diapers, wipes, toys, toiletries, accessories, and the like. It is believed that the unique scents provided with the products will trigger the positive response in the consumers due to the previous association and will effectively transfer that positive response to the marketed products.

Another example of marketing a product to a consumer before the consumer has a need for the product being marketed includes providing positive stimulus (e.g., free music download coupons or prize codes) contemporaneously with a unique scent to pre-pubescent girls. The positive stimulus is believed to result in a positive response from the pre-pubescent girls. The combination of a positive response and the unique scent is believed to build a positive association between the response and the unique scent. This step may be repeated one or more times and may additionally include the lapse of time between steps such that a powerful association may be established between the positive response and the unique scent over time. The method of this embodiment further includes the step of providing feminine hygiene articles that include the unique scent such that when the girls reach puberty the positive response to the given scent can be transferred to the feminine hygiene products containing the scent thereby creating a positive response to the feminine hygiene products from her first exposure.

In a more specific example, the female subjects could be provided with one or more books containing advice on puberty and/or other issues affecting girls and women. The books are expected to provide a positive stimulus which should result in a positive response. The books also include a unique fragrance to begin building the association between the positive response and the unique odor. Once the association is developed, the method includes providing feminine hygiene products, personal hygiene products, spa products, and the like, with the unique fragrance such that the positive response associated with the unique scent is transferred to the products containing that unique scent.

In another embodiment, a method of marketing a product may include providing items such as, for example, envelopes, paper, cards, pens, gift wrap, and the like, and combinations thereof, with a unique scent. The items may be provided in conjunction with a baby shower. For example, expectant mothers may be provided with shower invitations, envelopes, and/or pens containing the unique scent. The excitement of preparing the invitations for the shower is likely to create a positive response in the expectant mother thereby creating a positive association between the response and the scent. Similarly, the recipients of the invitations will likely have a positive response to the baby shower and also develop a positive association between the response and the scent. Once the association has been established in the expectant mother and/or the invitation recipients, the method further includes providing one or more products with the scent. For example, the product could include baby items, such as, for example, diapers, wipes, clothes, toys, blankets, bedding, totes, and the like and combinations thereof. The positive response is likely to be transferred to the products because of the previously established positive association with the scent.

In some embodiments, the stimulus may be more closely related to the product to be marketed. For example, the product to be marketed may be a diaper. A method for marketing the diapers may include providing a stimulus, e.g., coupons, contemporaneously with the fragrance to build an association between the positive response in the subject and the fragrance on the diapers. The coupons, i.e., the stimulus, may be used to purchase the diapers being marketed and containing the fragrance. Therefore, the stimulus in this example is closely related to the product being marketed.

In some embodiments, the stimulus may be less closely related to the product to be marketed. For example, the product to be marketed may be a diaper. A method for marketing the diaper may include providing a stimulus, e.g., tickets to an amusement park, contemporaneously with the unique fragrance to build a positive association between the positive response produced by receiving the tickets and the unique fragrance. The method may also then include providing the diaper with the unique fragrance such that the positive association developed with the fragrance is transferred to the diaper being marketed even before the diaper is used. Therefore the stimulus in this example is not closely related to the product being marketed.

In various embodiments, the stimulus and/or the scent may be presented multiple times to build the association. The association of the scent and the positive response may be strengthened through repetitive and contemporaneous exposures to the scent and the positive response. For example, the method may include providing the consumer with a coupon containing the scent to start to build the positive association with the scent. Later, the method may include providing the consumer with another coupon and/or some other stimulus that is delivered contemporaneously with the scent to continue to strengthen the positive association with the scent. The method may finally include providing one or more products with the scent. When the consumer is finally exposed to the products with the scent, the positive response is believed to be transferred to the products because of the association between the scent and the positive response.

Additionally, or alternatively, the stimulus type and/or strength and/or value may be different in various presentations. For example, the stimulus strength and/or value may become progressively greater each time it is provided to the subject to increase the positive response and consequently increase the association with the scent. Additionally or alternatively, the scent may be provided to the subject with different intensities at different times. For example, the scent may be provided to the subject at subsequent times with increasingly greater intensity to increase the strength of the association.

For example, a first coupon having a first value may be provided to a subject contemporaneously with a unique fragrance. At a later time, a second coupon having a second value may be provided to the subject contemporaneously with the unique fragrance wherein the second value is different (lesser or greater) than the first value. At yet later times, one or more subsequent coupons having values different (lesser or greater) than the previous coupons may be presented to the subject contemporaneously with the fragrance.

In another example, a first coupon having a first value may be presented to a subject contemporaneously with a fragrance having a first intensity. At a later time, a second coupon having a second value may be presented to the subject contemporaneously with the fragrance having a second intensity wherein the second value is the same as the first value and the second intensity is different (lesser or greater) than the first intensity. At yet later times, one or more subsequent coupons having the same value as the previous coupons may be presented to the subject contemporaneously with progressively increasing fragrance intensity.

In yet another example, a first coupon having a first value may be presented to a subject contemporaneously with a unique fragrance having a first intensity. At a later time, a second coupon having a second value may be presented to the subject contemporaneously with the unique fragrance having a second intensity wherein the second value is different (lesser or greater) than the first value and the second intensity is different (lesser or greater) than the first intensity. At yet later times, one or more subsequent coupons, each having a greater value than the previous coupons, may be presented to the subject contemporaneously with progressively increasing fragrance intensity.

As various changes could be made in the above methods, without departing from the scope of the invention, it is intended that all matter contained in the above description shall be interpreted as illustrative and not in a limiting sense. When introducing elements of the invention or the preferred aspect(s) thereof, the articles “a,” “an,” “the,” and “said” are intended to mean that there are one or more of the elements. The terms “comprising,” “including,” and “having” are intended to be inclusive and mean that there may be additional elements other than the listed elements.

1. A method of marketing a product, comprising,
providing a unique scent contemporaneously with an unrelated positive stimulus in the absence of the product, and
later providing the product with the unique scent.

2. The method of claim 1 wherein the stimulus does not direct attention to the product.

3. The method of claim 1 wherein the stimulus does not direct attention to the scent.

4. The method of claim 3 wherein the stimulus does not direct attention to the product.

5. The method of claim 1 further comprising providing the unique scent contemporaneously with a second unrelated positive stimulus in the absence of the product.

6. The method of claim 5 wherein the first stimulus has a first value and the second stimulus has a second value greater than the first value.

7. The method of claim 1 wherein the positive stimulus is a gift pack, coupons, or food.

8. The method of claim 7 wherein the product is a diaper, wipe, children's toiletry, or tissue.

9. A method of marketing a product, comprising,
providing a unique scent with a first intensity contemporaneously with a first unrelated positive stimulus in the absence of the product, wherein the first unrelated positive stimulus has a first strength,
later providing the unique scent with a second intensity contemporaneously with a second unrelated positive stimulus in the absence of the product, wherein the second unrelated positive stimulus has a second strength, and
later providing the product with the unique scent.

10. The method of claim 9 wherein the first stimulus is a different type of stimulus than the second stimulus.

11. The method of claim 9 wherein the second intensity of the scent is greater than the first intensity of the scent.

12. The method of claim 11 wherein the first positive stimulus is a coupon having a first value and the second positive stimulus is a coupon having a second value and the second value is greater than the first value.

13. The method of claim 9 wherein the second strength of the second stimulus is greater than the first strength of the first stimulus.

14. The method of claim 13 wherein the second intensity of the scent is greater than the first intensity of the scent.

15. The method of claim 9 wherein the first and second stimuli do not direct attention to the product.

16. The method of claim 9 wherein the first and second stimuli do not direct attention to the scent.

17. A method of marketing a product, comprising,
providing a unique scent with a first intensity contemporaneously with a first unrelated positive stimulus in the absence of the product, wherein the first unrelated positive stimulus has a first strength,
later providing the unique scent with a second intensity contemporaneously with a second unrelated positive stimulus in the absence of the product, wherein the second positive stimulus has a second strength, wherein the second intensity of the scent is greater than the first intensity of the scent, and wherein the second strength of the second stimulus is greater than the first strength of the first stimulus; and
later providing the product with the unique scent.

18. The method of claim 17 wherein the first and second stimuli do not direct attention to the product.

19. The method of claim 17 wherein the first and second stimuli do not direct attention to the scent.

20. The method of claim 19 wherein the first and second stimuli do not direct attention to the product.
